(19) United States
(12) Patent Application Publication
(10) Pub. No.: US 2009/0307572 A1
(43) Pub. Date: Dec. 10, 2009

(54) TV set and remote guide to represent a web site home page

(76) Inventor: Zak Zacharia, Valley Center, CA (US)

Correspondence Address: ZAK ZACHARIA, BOX 468, VALLEY CANTER, CA, 92082, US

(21) Appl. No.: 12/042,319

(22) Filed: Mar. 4, 2008

(51) Int. Cl. G06F 17/00; G06F 17/30

(52) U.S. Cl. 715/205; 715/234; 707/3; 707/E17.014

(57) ABSTRACT

Internet web site pages are typically designed as a magazine or book page with test and graphics. The layout normally represents the message and intended function of the web site. In general, a web site home page derives its roots from the print media in terms of its looks, feel, message, and intended audience.

The design proposed in this invention departs from the traditional print guidelines and presents its audience with the image of a TV set and an animated remote control device, called the TV Guide in this patent. The TV Guide has all the controls the user needs to navigate the web site and it also serves as the TV programs guide listing all available TV networks, stations, and shows. The TV set serves as a device to display graphics and play videos.

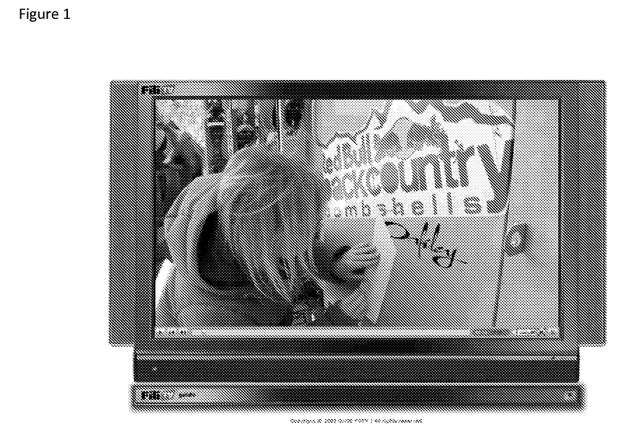

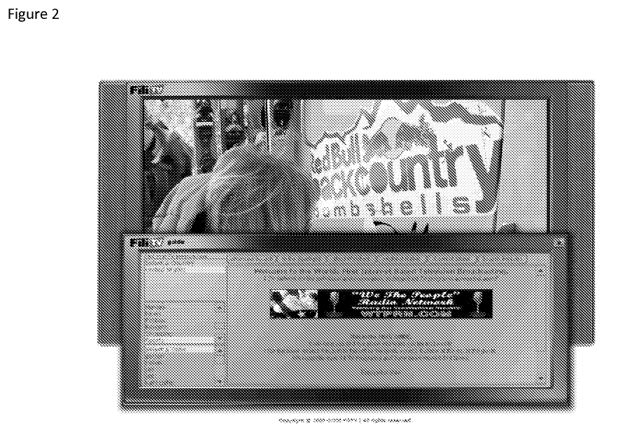

The 4 images included in this filing illustrate one design that depicts the use of the TV set and its remote control device (the TV Guide). FIG. 1. The TV Guide (remote control) is represented in the bar at the bottom of the TV set. The user can click on the TV Guide and it will slowly expand and open to display the TV programs as see in FIG. 2.

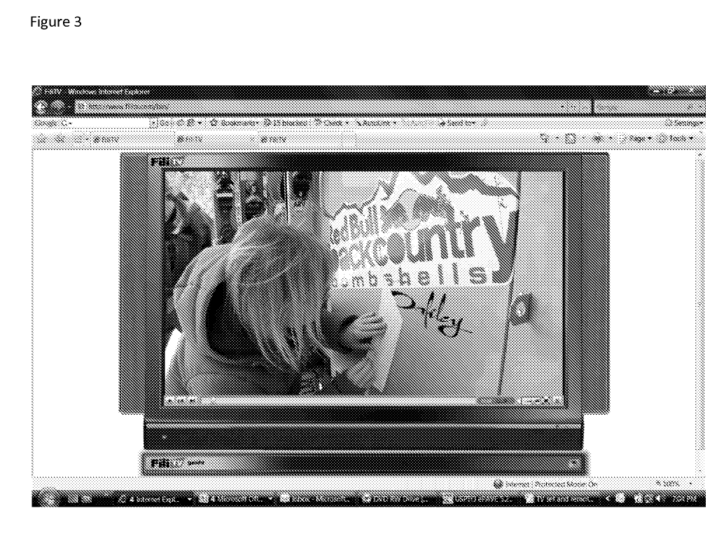

The entire web site screen is captured to show this design patent in a regular Internet browser page, FIG. 3.

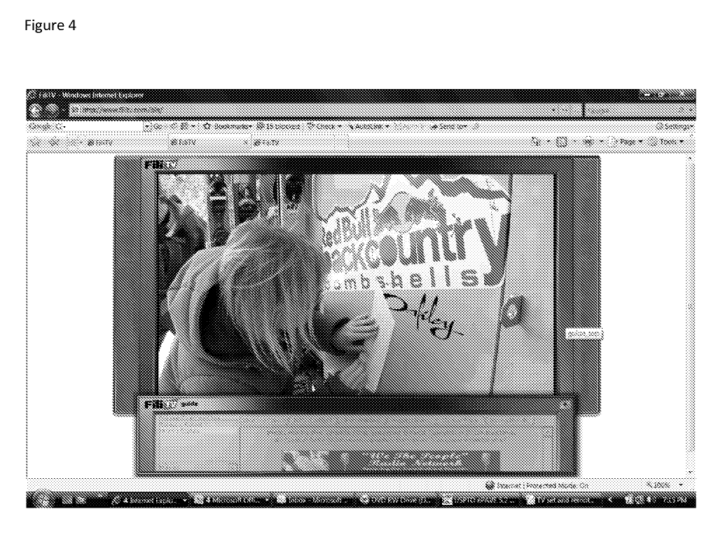

FIG. 4 shows the TV Guide while in transition from closed to open.

1. An Internet web site page represented as a TV set and its remote control

2. The TV set and remote control having any color, texture, or ergonomic design

3. An animated remote control in claim 1 that opens and closes in response to the users demands.

4. The remote control acting also as a TV Guide, allowing the user to select Networks, TV stations and program. Or any subject selection tree.

5. The remote control having search engine capability allowing the user to submit search terms to receive search results

6. The remote control allowing the placement of advertisements in still graphic form, animations, or video.

7. The remote control having links to regular Internet web pages.

8. The remote control having the capability to change background colors based on users choices.
